(19) United States
(12) Patent Application Publication
(10) Pub. No.: US 2008/0035827 A1
(43) Pub. Date: Feb. 14, 2008

(54) Tree supporting device and method

(76) Inventor: Edgardo Clores, Las Vegas, NV (US)

Correspondence Address: WEISS & MOY PC, 4204 NORTH BROWN AVENUE, SCOTTSDALE, AZ, 85251, US

(21) Appl. No.: 11/731,886

(22) Filed: Apr. 2, 2007

Related U.S. Application Data
(63) Continuation-in-part of application No. 11/500,729, filed on Aug. 8, 2006.

(51) Int. Cl. A01K 97/10

(52) U.S. Cl. 248/534

(57) ABSTRACT

A pole-type member support device and method may be utilized to support, among other things, Christmas trees. A molded receptacle body has a multi-sided opening therein, to receive the pole-type member. The pole-type member is secured in position by a moveable support member, which may be a threaded shaft, which is inserted through the receptacle body and which extends into the interior of the opening, so that it may contact the pole-type member. In one embodiment, the threaded shaft has a handle, to facilitate turning thereof.

### RELATED APPLICATIONS

This application is related to application Ser. No. 11/500,729 filed Aug. 8, 2006, entitled POLE-TYPE MEMBER SUPPORT DEVICE AND METHOD THEREFOR by one of the same named inventors and is incorporated by reference.

### FIELD OF THE INVENTION

This invention relates tree supporting devices and methods and more specifically to a tree support device and method for securely supporting trees and other elongated objects in an upright position for an extended period of time.

### BACKGROUND OF THE INVENTION

During the holiday season, many people bring Christmas trees into their homes for both decorative and religious purposes. The Christmas trees often vary in height and size, creating varying degrees of difficulty in supporting the trees in a stable position. Other people purchase or rent trees, tiki torches or other pole-type items for special events and occasions. In these cases as well, it is difficult to support these items in a stable manner. Often, the result is that the trees, poles or other items are either leaned against a wall or propped up in some other unstable way. This lack of a proper support device can lead to a number of unwanted consequences. A tree falling from an unstable position can cause not only property damage but can also physical harm to a person. Likewise, a falling tiki torch or a pole-type item with a candle or other lit object on top could ignite a fire.

Previous attempts have been made to provide a support device for Christmas trees. For example, U.S. Pat. No. 5,970,655 issued to Freeman discloses a Christmas tree resting inside a collar member having a radial extension and a rod between the tree and the radial extension. The Freeman patent requires the attachment of a rod to a portion of the tree, a time-consuming and difficult process. Additionally, the Freeman patent does not provide a collar capable of being adjusted to the varying thickness of different trees or other pole-type members.

Accordingly, there has been a need for a pole-type member support device which is of simplified construction, and inexpensive to manufacture. Such a device is also needed which holds a pole-type member in a fixed relationship for an extended period of time. A still further need exists for a pole member support device capable of being adjusted to securely support a tree or other pole-type member of varying degrees of thickness. The present invention fulfills these needs and provides other related advantages.

### SUMMARY OF THE INVENTION

In accordance with an embodiment of the present invention, a pole-type member support device for securing pole-type members of varying thickness in an upright position is disclosed. The device comprises, in combination: a molded hollow receptacle body adapted to receive a portion of a pole-type member having a multi-sided opening; a moveable support member positioned within the molded hollow receptacle body for cooperatively holding the pole-type member upright in the receptacle body within the multi-sided opening; and wherein the moveable support member comprises a threaded shaft adapted to be alternatively inserted into and withdrawn from the multi-sided opening.

In accordance with another embodiment of the present invention, a pole-type member support device for securing pole-type members of varying thickness in an upright position is disclosed. The device comprises, in combination: a molded hollow receptacle body adapted to receive a portion of a pole-type member having a multi-sided opening; wherein the receptacle body comprises an upper tier and a separate lower tier and wherein the multi-sided opening is continuous from the upper tier to the lower tier; a base positioned below the lower tier; a moveable support member positioned within the molded hollow receptacle body for cooperatively holding the pole-type member upright in the receptacle body within the multi-sided opening; and wherein the moveable support member comprises a threaded shaft adapted to be alternatively inserted into and withdrawn from the multi-sided opening.

In accordance with a further embodiment of the present invention, a method for supporting a pole-type member is disclosed. The method comprises: providing a molded hollow receptacle body adapted to receive a portion of a pole-type member having a multi-sided opening; providing a moveable support member positioned within the molded hollow receptacle body for cooperatively holding the pole-type member upright in the receptacle body within the multi-sided opening; wherein the moveable support member comprises a threaded shaft adapted to be alternatively inserted into and withdrawn from the multi-sided opening; positioning a portion of a pole-type member into the multi-sided opening; inserting the threaded shaft into the multi-sided opening until an end portion thereof contacts the pole-type member upright.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective environmental view of a pole-type member support device consistent with an embodiment of the present invention, illustrating an object, shown in phantom, secured in an upright position therein;

FIG. 2 is a perspective view of the pole-type member support device of FIG. 1, illustrating a tree secured therein;

FIG. 3 is a perspective view of a pole-type member support device consistent with another embodiment of the present invention, illustrating a base member in the form of a molded Santa sack shell encasing a receptacle body;

FIG. 4 is atop view of the device of FIG. 3;

FIG. 5 is a perspective view of a pole-type member support device consistent with another embodiment of the present invention, having a substantially S-shaped base;

FIG. 6 is a top view of the device of FIG. 5;

FIG. 7 is a perspective view of a pole-type member support device consistent with another embodiment of the present invention, having a substantially S-shaped base;

FIG. 8 is a top view of the device of FIG. 7; and

FIG. 9 is a top view of the base portion of the device of FIGS. 7-8.

### DETAILED DESCRIPTION OF THE PREFERRED EMBODIMENTS

As shown in the drawings for purposes of illustration the present invention is concerned with an improved pole-type member support device, generally designated in the accompanying drawings by the reference number 10. The pole-type member support device comprises, generally, a hollow receptacle body 12 adapted to receive a pole-type member 14, a moveable support member 16 positioned on the hollow receptacle body 12 and cooperating therewith to hold the pole-type member 14 upright in the receptacle body 12, and capable of accommodating pole-type members of varying thickness. The pole-type member support device may further comprise a base member 22 or 42.

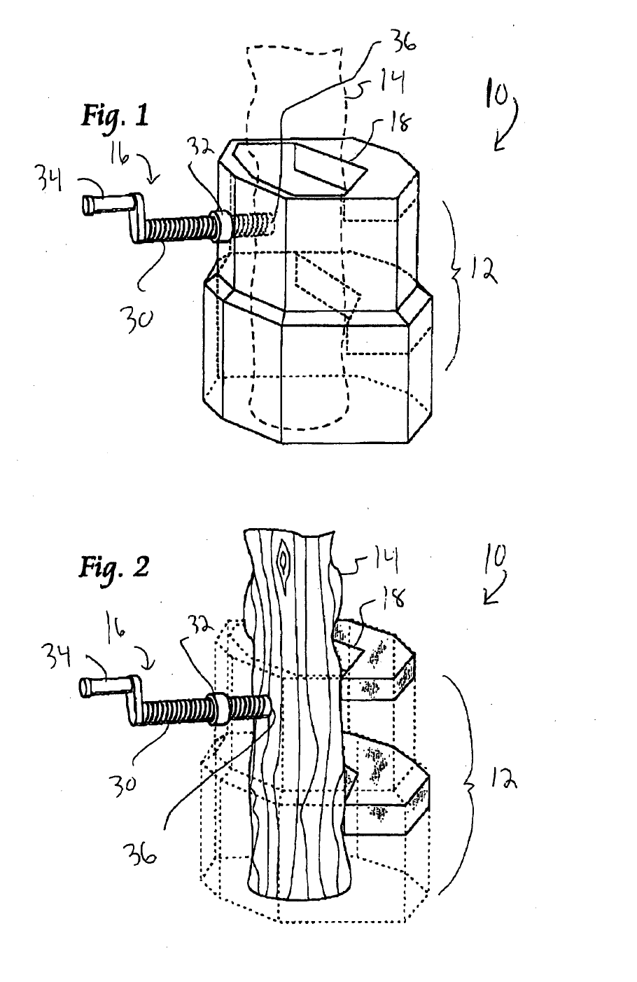

In accordance with the present invention, and as illustrated with respect to a preferred embodiment in FIGS. 1 through 9, the improved pole-type member support device 10 is configured for stable placement on a surface to hold a pole-type member, including a Christmas tree or the like, upright for an extended period of time. The improved pole-type member support may be constructed to contain water to keep the tree hydrated during is positioning in the device.

Referring first to FIGS. 1-2, an embodiment of a support device 10 is illustrated In this embodiment, the device 10 comprises a hollow receptacle body 12 having a pole receiving opening 18 therein. The opening 18 may be, as illustrated herein, multi-sided, to provide improved retention of the member 14. The moveable support member 16 may comprise, as illustrated herein, a threaded shaft 30 engaged within a mated, threaded ring 32 positioned on the receptacle body 12. The moveable support member 16 may further comprise a handle 34, to permit rotation of the threaded shaft 30 and, depending on a direction of such rotation, insertion or withdrawal of the shaft 30 relative to the interior of the receptacle body 12. Upon positioning of the member 14 in the receptacle body 12, it will be desired to turn the handle 34 until an end 36 of the moveable support member 16 contacts the support member 14. For increased security, and depending on the material comprising the moveable support member 16, it may be desired to tighten the support member 16 sufficiently so that the end 36 deforms or penetrates an exterior of the member 14.

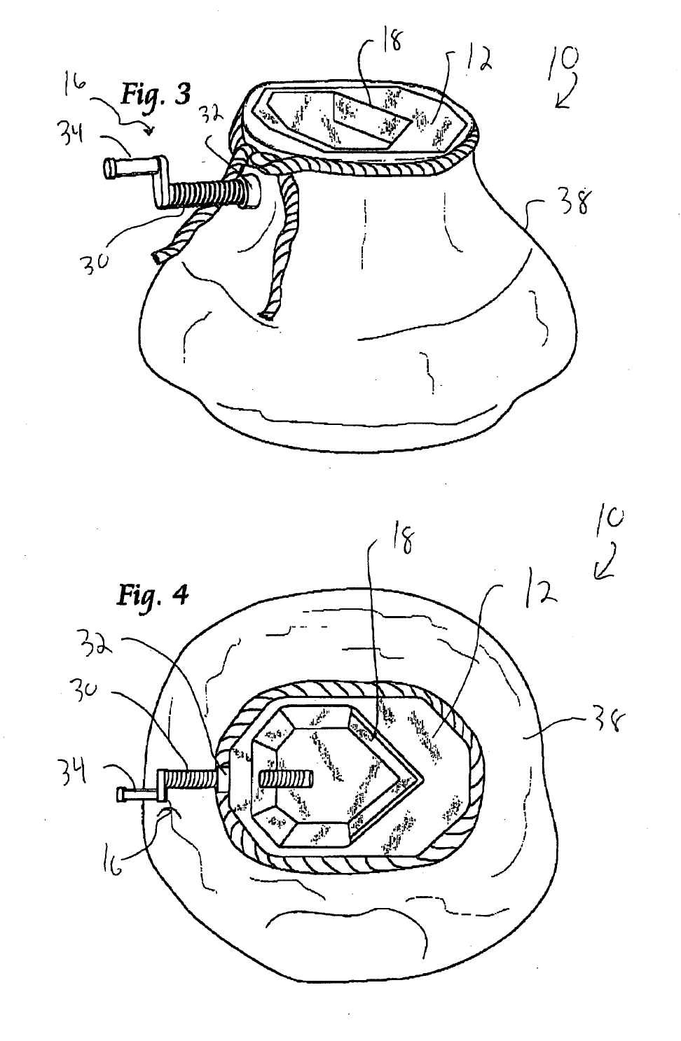

Referring now to FIGS. 3-4, in this embodiment, the body 12 has an outer appearance of a gift or “Santa” sack 38. Internal to the sack 38, the device 10 has the same components as the embodiment illustrated in FIGS. 1-2—a multi-sided opening 18 and a moveable support member 16 comprising a threaded shaft 30 engaged within a mated, threaded ring 32 positioned on the receptacle body 12 and having a handle 34. Operation is as described above with respect to the embodiment of FIGS. 1-2, with the handle 34 being rotated in a desired rotation to cause insertion or withdrawal of the shaft 30 relative to the interior of the receptacle body 12 and the securing or release of the member 14.

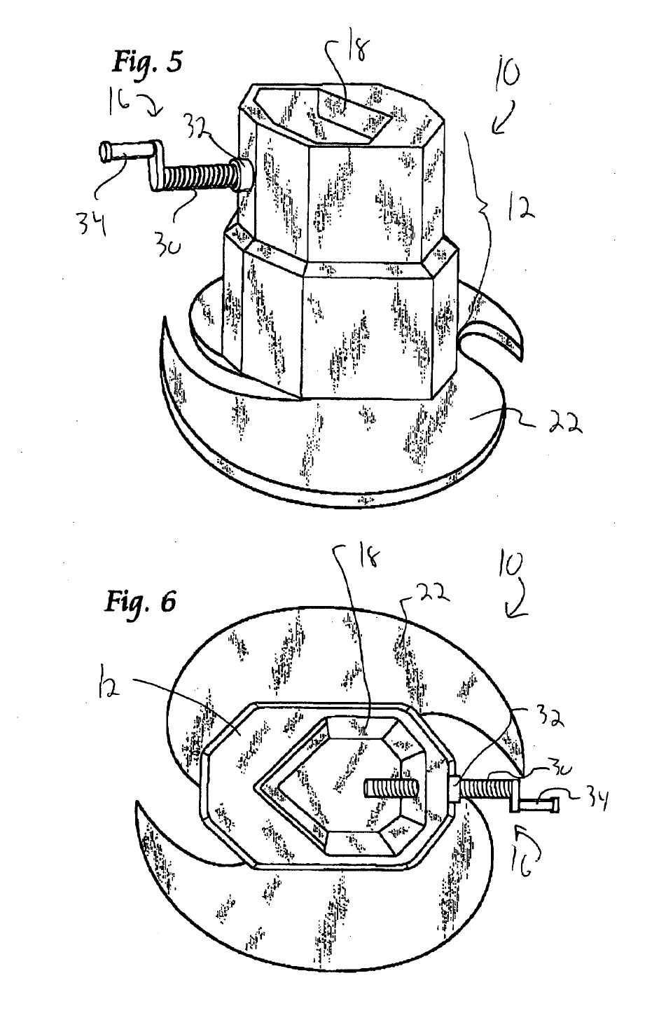

Referring now to FIGS. 5-6, in this embodiment, the device 10 further comprises a base 22. The base 22 has a broader footprint than the underside of the body 12, so as to provide increased stability in this embodiment, the base 22 has a substantially S-shape, which may signify the first letter of “Santa.” Above the base 22, the device 10 has the same components as the embodiment illustrated in FIGS. 1-2—a multi-sided opening 18 and a moveable support member 16 comprising a threaded shaft 30 engaged within a mated, threaded ring 32 positioned on the receptacle body 12 and having a handle 34. Operation is as described above with respect to the embodiment of FIGS. 1-2, with the handle 34 being rotated in a desired rotation to cause insertion or withdrawal of the shaft 30 relative to the interior of the receptacle body 12 and the securing or release of the member 14.

It should be noted that in the embodiments of FIGS. 1-2 and 5-6, the body 12 has an upper and a lower tier. These tiers may form part of a one-piece assembly or, optionally, they may form two stackable components which may or may not be incorporated into a single device 10 by a user depending on the size and/or weight thereof. (It should be noted that a two-piece assembly may be desired, even if the device 10 were to be intended to always be used with both the upper and lower tier, for packaging purposes.

With respect to the base 22 illustrated in FIGS. 5-6, it should be noted that it can be part of a one-piece assembly of the device 10, part of a one piece assembly with the lower tier only, or a separate component from the upper and lower tier altogether. If the base 22 is to be provided as a separate component, it may be desired to provide a snap, tab, or other coupling means (not shown) to facilitate secure coupling between the base 22 and the lower tier of the body 12.

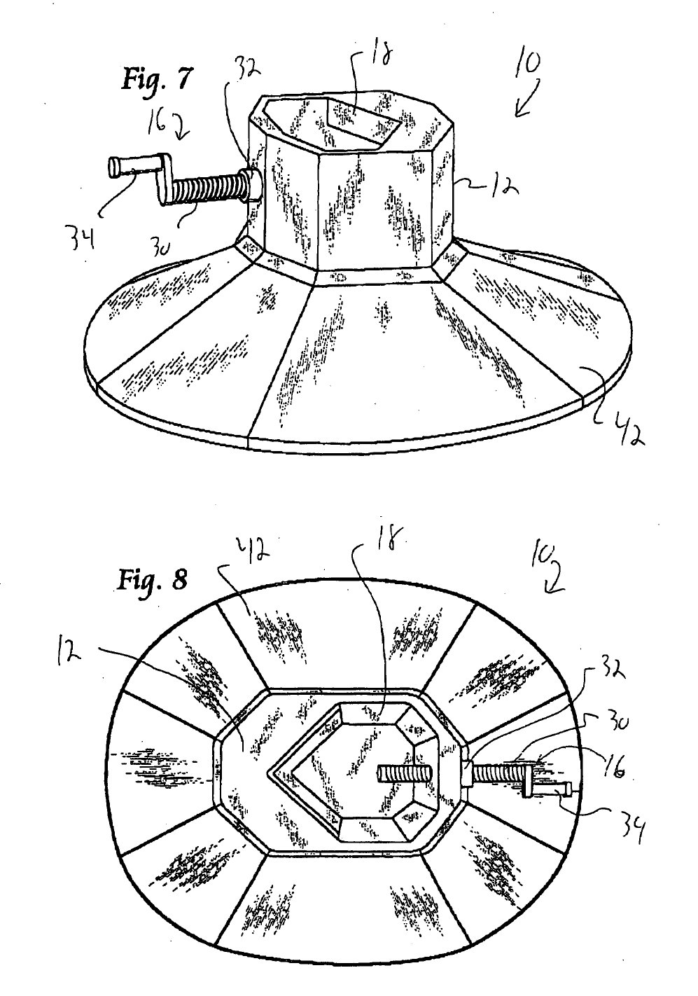

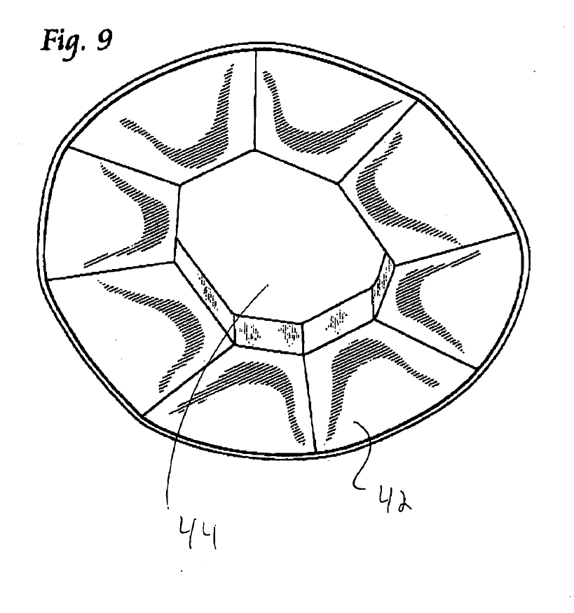

Referring now to FIGS. 7-8, another embodiment of the device 10 of the present invention is shown. The device 10 has the same basic components as the embodiment illustrated in FIGS. 1-2—a multi-sided opening 18 and a moveable support member 16 comprising a threaded shaft 30 engaged within a mated, threaded ring 32 positioned on the receptacle body 12 and having a handle 34. Operation is as described above with respect to the embodiment of FIGS. 1-2, with the handle 34 being rotated in a desired rotation to cause insertion or withdrawal of the shaft 30 relative to the interior of the receptacle body 12 and the securing or release of the member 14.

The embodiment of FIGS. 7-8 differs from the embodiment of FIGS. 1-2, however, in several respects. First, it should be noted that, in this embodiment, the receptacle body 12 has only a single tier. Second, in this embodiment, a base 42 is provided. Referring additionally to FIG. 9, it can be seen that it may be desired to provide the base 42 as a separate component, having a receiver 44 configured to securely receive therein the receptacle body 12. Supplemental fastening means, such as snaps or tabs or the like (not shown) may optionally be provided, to further ensure secure coupling between the receptacle body 12 and the base 42.

The receptacle body 12 may be blow-molded or the like from a hard plastic to provide a substantially stable base able to support the weight and height of the pole-type member as well as the weight of the water, if used. The material used may be substantially waterproof to contain water for an extended period of time. A suitable plastic material may be polyethylene plastic or the like.

From the foregoing, it is to be appreciated that these improved pole-type member support devices of the present invention provide maximum stabilization to hold the pole-type member in an upright position, while being easy to use. It is also to be appreciated that pole-type members of varying thickness may be held securely upright. In the case of trees, the ability of these pole-type member support devices to contain water help increase the moisture and longevity of the trees stabilized therein.

Although a particular embodiment of the invention has been described in detail for purposes of illustration, various modifications may be made without departing from the spirit and scope of the invention. Accordingly, the invention is not to be limited, except as by the appended claims.

I claim:

1. A pole-type member support device for securing pole-type members of varying thickness in an upright position, comprising:
a molded hollow receptacle body adapted to receive a portion of a pole-type member having a multi-sided opening;
a moveable support member positioned within the molded hollow receptacle body for cooperatively holding the pole-type member upright in the receptacle body within the multi-sided opening; and
wherein the moveable support member comprises a threaded shaft adapted to be alternatively inserted into and withdrawn from the multi-sided opening.

2. The pole-type member support device of claim 1 wherein the receptacle body comprises an upper tier and a separate lower tier and wherein the multi-sided opening is continuous from the upper tier to the lower tier.

3. The pole-type member support device of claim 1 further comprising a base positioned below the support member.

4. The pole-type member support device of claim 3 wherein the base has a substantially “S” shape.

5. The pole-type member support device of claim 3 wherein the base is separable from the support member.

6. The pole-type member support device of claim 2 further comprising a base positioned below the lower tier.

7. The pole-type member support device of claim 6 wherein the base has a substantially “S” shape.

8. The pole-type member support device of claim 1 wherein the receptacle body has an external configuration of a gift sack.

9. A pole-type member support device for securing pole-type members of varying thickness in an upright position, comprising:
a molded hollow receptacle body adapted to receive a portion of a pole-type member having a multi-sided opening;
wherein the receptacle body comprises an upper tier and a separate lower tier and wherein the multi-sided opening is continuous from the upper tier to the lower tier;
a base positioned below the lower tier;
a moveable support member positioned within the molded hollow receptacle body for cooperatively holding the pole-type member upright in the receptacle body within the multi-sided opening; and
wherein the moveable support member comprises a threaded shaft adapted to be alternatively inserted into and withdrawn from the multi-sided opening.

10. The pole-type member support device of claim 9 wherein the base has a substantially “S” shape.

11. The pole-type member support device of claim 9 wherein the base is separable from the support member.

12. A method for supporting a pole type member comprising:
providing a molded hollow receptacle body adapted to receive a portion of a pole-type member having a multi-sided opening;
providing a moveable support member positioned within the molded hollow receptacle body for cooperatively holding the pole-type member upright in the receptacle body within the multi-sided opening;
wherein the moveable support member comprises a threaded shaft adapted to be alternatively inserted into and withdrawn from the multi-sided opening;
positioning a portion of a pole-type member into the multi-sided opening;
inserting the threaded shaft into the multi-sided opening until an end portion thereof contacts the pole-type member upright.

13. The method of claim 12 wherein the receptacle body comprises an upper tier and a separate lower tier and wherein the multi-sided opening is continuous from the upper tier to the lower tier.

14. The method of claim 12 further comprising positioning a base below the support member.

15. The method of claim 14 wherein the base has a substantially “S” shape.

16. The method of claim 14 wherein the base is separable from the support member.

17. The method of claim 13 further comprising positioning a base below the lower tier.

18. The method of claim 17 wherein the base has a substantially “S” shape.

19. The method of claim 12 wherein the receptacle body has an external configuration of a gift sack.
